(19) United States
(12) Patent Application Publication
(10) Pub. No.: US 2025/0238279 A1
(43) Pub. Date: Jul. 24, 2025

(54) INPUT-OUTPUT SCHEDULING FOR VIRTUALIZED COMPUTING INSTANCES SENDING INPUT-OUTPUT REQUESTS TO SHARED STORAGE

(71) Applicant: Dell Products L.P., Round Rock, TX (US)

(72) Inventors: Jian Kang, Chengdu (CN); Jie Wang, Chengdu (CN); Qian Wu, Chengdu (CN)

(21) Appl. No.: 18/433,719

(22) Filed: Feb. 6, 2024

(30) Foreign Application Priority Data
Jan. 22, 2024 (CN) 202410088807.9

(51) Int. Cl. G06F 9/50

(52) U.S. Cl. CPC G06F 9/5077; G06F 9/5038

(57) ABSTRACT

An apparatus comprises at least one processing device configured to identity input-output (IO) workload classifications for virtualized computing instances issuing IO requests to a shared storage system, and to determine groupings of the virtualized computing instances based on the IO workload classifications. The at least one processing device is also configured to generate multiple IO queues associated with different IO priority levels for a given workload group, to sort IO requests receives from the virtualized computing instance of the given workload group into different ones of the multiple IO queues based on information characterizing (i) a time to service IO requests given available resources of the shared storage system and (ii) wait times for IO requests received from the virtualized computing instances of the given workload group, and to process the IO requests based on the different priority levels of the multiple IO queues.

### RELATED APPLICATION

The present application claims priority to Chinese Patent Application No. 202410088807.9, filed on Jan. 22, 2024 and entitled “Input-Output Scheduling for Virtualized Computing Instances,” which is incorporated by reference herein in its entirety.

### BACKGROUND

Information processing systems increasingly utilize reconfigurable virtual resources to meet changing user needs in an efficient, flexible and cost-effective manner. For example, cloud computing and storage systems implemented using virtual resources such as virtual machines have been widely adopted. Other virtual resources now coming into widespread use in information processing systems include Linux containers. Such containers may be used to provide at least a portion of the virtualization infrastructure of an information processing system. Applications running on containers, virtual machines or other virtual resources may include one or more processes that perform the application functionality, and which issue input-output (IO) requests for delivery to storage systems, including storage systems which are shared by multiple containers, virtual machines or other virtual resources. Storage controllers of the storage systems service such IO requests.

### SUMMARY

Illustrative embodiments of the present disclosure provide techniques for IO scheduling for virtualized computing instances issuing IO requests to shared storage.

In one embodiment, an apparatus comprises at least one processing device comprising a processor coupled to a memory. The at least one processing device is configured to identify, for each of a plurality of virtualized computing instances issuing IO requests to a shared storage system, an IO workload classification. The at least one processing device is also configured to determine two or more virtualized computing instance workload groups based at least in part on the identified IO workload classifications of the plurality of virtualized computing instances, each of the two or more virtualized computing instance workload groups comprising a different subset of the plurality of virtualized computing instances. The at least one processing device is further configured to generate, for at least a given one of the two or more virtualized computing instance workload groups, two or more IO queues associated with different IO priority levels. The at least one processing device is further configured to sort IO requests received from the subset of the plurality of virtualized computing instances in the given virtualized computing instance workload group into the two or more IO queues, wherein a given one of the IO requests received from a given virtualized computing instance in the subset of the plurality of virtualized computing instances of the given virtualized computing instance workload group is placed in a given one of the two or more IO queues based at least in part on information characterizing servicing of IO requests by the shared storage system. The at least one processing device is further configured to process the IO requests received from the subset of the plurality of virtualized computing instances in the given virtualized computing instance workload group based at least in part on the different priority levels associated with the two or more IO queues.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for IO scheduling for virtualized computing instances issuing IO requests to shared storage in an illustrative embodiment.

FIG. 2 is a flow diagram of an exemplary process for IO scheduling for virtualized computing instances issuing IO requests to shared storage in an illustrative embodiment.

FIG. 3 shows a system configured for multi-priority IO request scheduling in a container-based hyperconverged infrastructure environment in an illustrative embodiment.

FIG. 4 shows a process for separating an IO request flow into IO request queues with different priorities in an illustrative embodiment.

FIG. 5 shows a table illustrating sample characteristics for IO datasets used in characterizing IO workloads in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

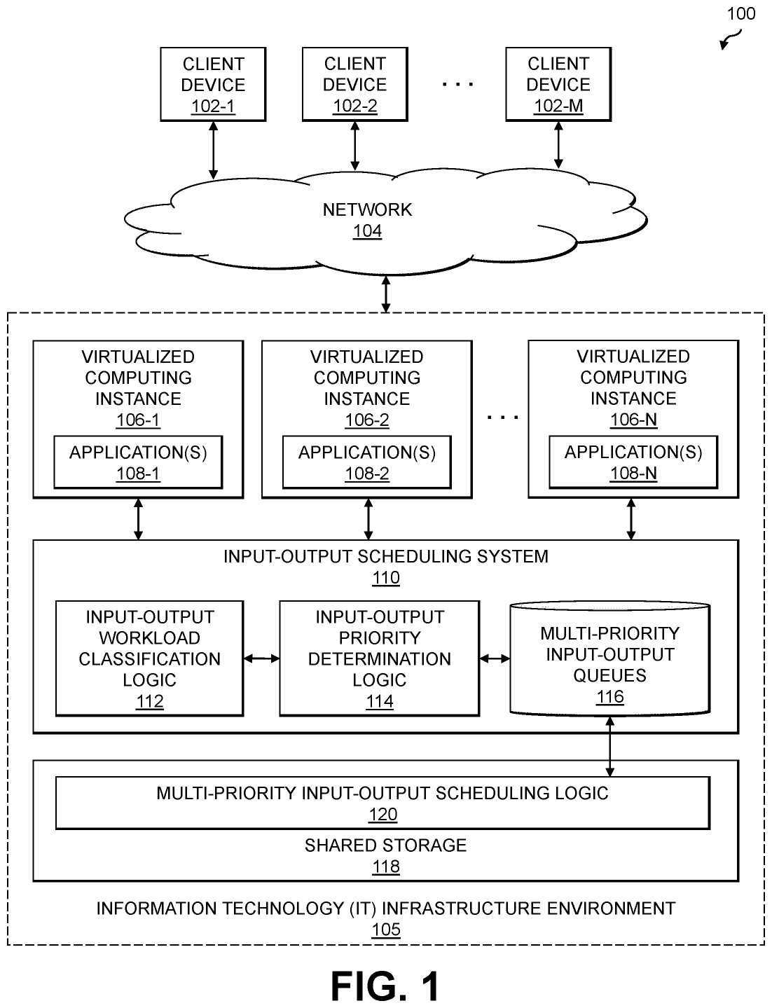

FIG. 1 shows an information processing system 100 configured in accordance with an illustrative embodiment. The information processing system 100 is assumed to be built on at least one processing platform and provides functionality for IO scheduling for virtualized computing instances issuing IO requests to be serviced by a shared storage system. The information processing system 100 includes a set of client devices 102-1, 102-2, . . . 102-M (collectively, client devices 102) which are coupled to a network 104. Also coupled to the network 104 is an information technology (IT) infrastructure environment 105 comprising a set of virtualized computing instances 106-1, 106-2, . . . 106-N(collectively, virtualized computing instances 106) which run respective sets of one or more applications 108-1, 108-2, . . . 108-N(collectively, applications 108). The client devices 102 are assumed to utilize the applications 108 running on the virtualized computing instances 106, which will generate various IO requests that need to be serviced utilizing a shared storage 118 in the IT infrastructure environment. The IT infrastructure environment 105 includes an IO scheduling system 110 which facilitates services of such IO requests directed to the shared storage 118.

The IO scheduling system 110 implements IO workload classification logic 112, IO priority determination logic 114 and a set of multi-priority IO queues 116. The virtualized computing instances 106, as part of running the applications 108, are assumed to issue IO requests to be serviced on the shared storage 118 of the IT infrastructure environment 105. The IO scheduling system 110 is configured to organize the virtualized computing instances 106, or the applications 108 running thereon, into different IO workload groups using the IO workload classification logic 112. Within each of the IO workload groups, the IO priority determination logic 114 assigns IO requests to different priority queues represented as the set of multi-priority IO queues 116. The shared storage 118 services requests from the multi-priority IO queues 116 utilizing multi-priority IO scheduling logic 120. The multi-priority IO scheduling logic 120 may be implemented by a storage controller or storage driver of the shared storage 118. For example, the shared storage may utilize a storage access protocol such as Non-Volatile Memory Express (NVMe), and the multi-priority IO scheduling logic 120 may be implemented utilizing an NVMe driver of the shared storage 118.

The virtualized computing instances 106 are assumed to be implemented utilizing one or more IT assets of the IT infrastructure environment, such as physical computing resources running a virtualization infrastructure. The virtualized computing instances 106 are illustratively software containers or other types of virtual computing resources such as virtual machines (VMs). In some embodiments, the IT infrastructure environment 105 comprises a hyperconverged infrastructure (HCI) environment. Where the virtualized computing instances 106 are implemented as software containers, this may be a container-based HCI environment.

Although the IO scheduling system 110 is shown as being external to the shared storage 118 in FIG. 1, it should be appreciated that in some embodiments, the IO scheduling system 110 may be implemented internal to the shared storage 118 (e.g., such as within one or more storage controllers or drivers thereof, which may also run or implement the multi-priority IO scheduling logic 120).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The shared storage 118 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

In some embodiments, the shared storage 118 is part of a software-defined IT infrastructure, such as a HCI including the virtualized computing instances 106, software-defined storage providing the shared storage 118, and virtualized networking (e.g., software-defined networking) linking the virtualized computing instances 106 with the shared storage 118.

Although not explicitly shown in FIG. 1, one or more input-output devices such as keyboards, displays or other types of input-output devices may be used to support one or more user interfaces to the IO scheduling system 110, as well as to support communication between the IO scheduling system 110 and other related systems and devices not explicitly shown.

In some embodiments, the client devices 102 are assumed to be associated with users of an enterprise, organization or other entity that also operates the IT infrastructure environment 105. In other embodiments, the client devices 102 may be associated with users of one or more enterprises, organizations or other entities different than the enterprise, organization or other entity which operates the IT infrastructure environment 105.

The IO scheduling system 110 and shared storage 118 in the FIG. 1 embodiment are assumed to be implemented using at least one processing device. Each such processing device generally comprises at least one processor and an associated memory, and implements one or more functional modules or logic for controlling certain features of the IO scheduling system 110 and/or the shared storage 118. In the FIG. 1 embodiment, the IO scheduling system 110 implements the IO workload classification logic 112, the IO priority determination logic 114 and the multi-priority IO queues 116, while the shared storage 118 implements the multi-priority IO scheduling logic 120. As noted above, in some embodiments the IO scheduling system 110 may be implemented internal to the shared storage 118, such that a same set of one or more processing devices (e.g., collectively providing or implementing a storage controller or storage driver of the shared storage 118) may implement the IO workload classification logic 112, the IO priority determination logic 114 and the multi-priority IO queues 116 and the multi-priority IO scheduling logic 120. In other embodiments, the multi-priority IO scheduling logic 120 may be implemented external to the shared storage 118, such as within the IO scheduling system 110. Various other combinations are possible. It is therefore to be appreciated that the particular arrangement of the client devices 102, the IT infrastructure environment 105, the virtualized computing instances 106, the IO scheduling system 110 and the shared storage 118 illustrated in the FIG. 1 embodiment is presented by way of example only, and alternative arrangements can be used in other embodiments.

At least portions of the IO workload classification logic 112, the IO priority determination logic 114 and the multi-priority IO queues 116 and the multi-priority IO scheduling logic 120 may be implemented at least in part in the form of software that is stored in memory and executed by a processor.

The IO scheduling system 110 and other portions of the information processing system 100, as will be described in further detail below, may be part of cloud infrastructure.

The IO scheduling system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure environment 105, the virtualized computing instances 106, the IO scheduling system 110 and the shared storage 118 or components thereof (e.g., the applications 108, the IO workload classification logic 112, the IO priority determination logic 114 and the multi-priority IO queues 116 and the multi-priority IO scheduling logic 120) may be implemented on respective distinct processing platforms, although numerous other arrangements are possible. For example, in some embodiments at least portions of the IO scheduling system 110 and the shared storage 118 are implemented on the same processing platform. Further, a given client device (e.g., 102-1) can be implemented at least in part within at least one processing platform that implements at least a portion of the IT infrastructure environment 105.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102 and the IT infrastructure environment 105, or portions or components thereof, to reside in different data centers. Numerous other distributed implementations are possible.

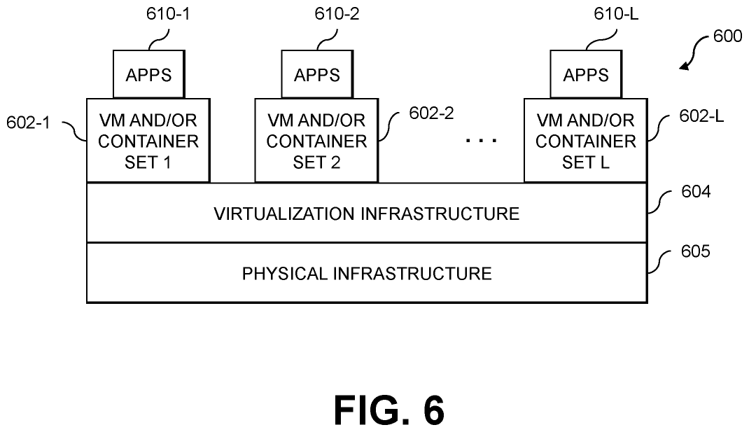

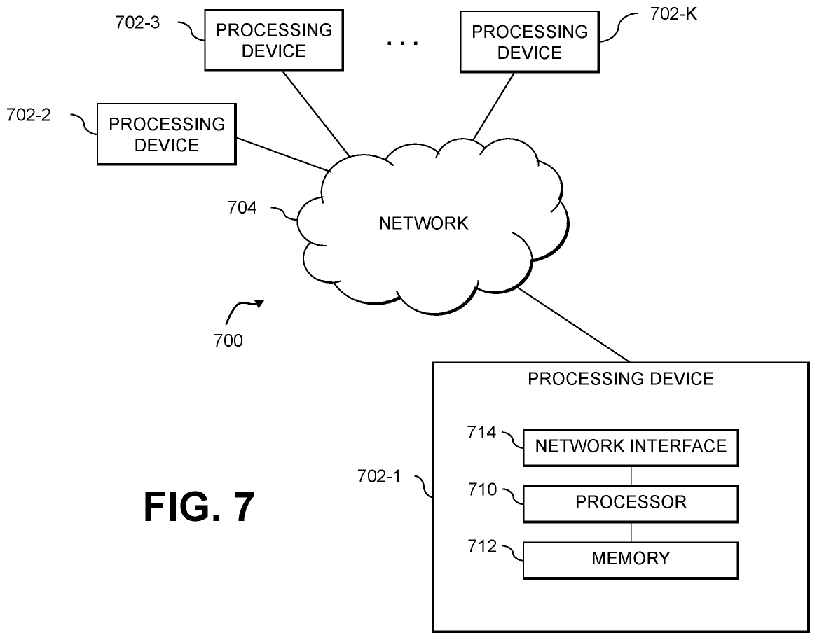

Additional examples of processing platforms utilized to implement the IO scheduling system 110 and other components of the information processing system 100 in illustrative embodiments will be described in more detail below in conjunction with FIGS. 6 and 7.

It is to be appreciated that these and other features of illustrative embodiments are presented by way of example only, and should not be construed as limiting in any way.

It is to be understood that the particular set of elements shown in FIG. 1 for IO scheduling for virtualized computing instances issuing IO requests to shared storage is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

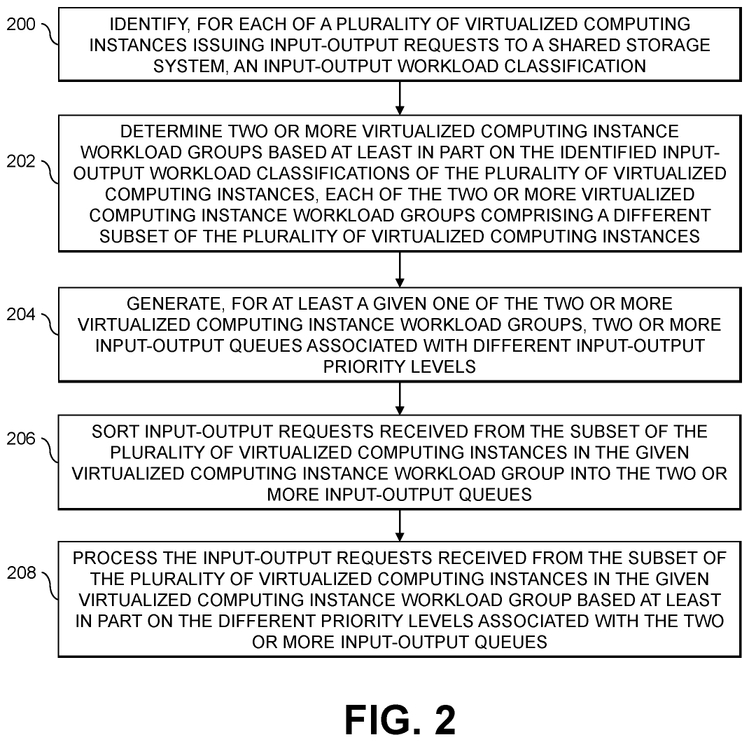

An exemplary process for IO scheduling for virtualized computing instances issuing IO requests to shared storage will now be described in more detail with reference to the flow diagram of FIG. 2. It is to be understood that this particular process is only an example, and that additional or alternative processes for IO scheduling for virtualized computing instances issuing IO requests to shared storage may be used in other embodiments.

In this embodiment, the process includes steps 200 through 208. These steps are assumed to be performed by the IO scheduling system 110 and/or the shared storage 118 utilizing the IO workload classification logic 112, the IO priority determination logic 114 and the multi-priority IO queues 116 and the multi-priority IO scheduling logic 120. The process begins with step 200, identifying, for each of the virtualized computing instances 106 issuing IO requests to the shared storage 118, an IO workload classification. The IT infrastructure environment may comprise an HCI environment. The virtualized computing instances 106 may comprise software containers, and the HCI environment may comprise a container-based HCI environment. The virtualized computing instances 106 and the shared storage 118 may run on common physical infrastructure in the container-based HCI environment.

In step 202, two or more virtualized computing instance workload groups are determined based at least in part on the identified IO workload classifications of the virtualized computing instances 106 in the IT infrastructure environment 105. Each of the virtualized computing instance workload groups comprises a different subset of the virtualized computing instances 106.

Two or more IO queues associated with different IO priority levels are generated for at least a given one of the two or more virtualized computing instance workload groups in step 204. IO requests received from the subset of the virtualized computing instances 106 in the given virtualized computing instance workload group are sorted into the two or more IO queues in step 206. A given IO request received from a given virtualized computing instance in the subset of the virtualized computing instances 106 of the given virtualized computing instance workload group is placed in a given one of the two or more IO queues based at least in part on information characterizing servicing of IO requests by the shared storage 118. The information characterizing the servicing of IO requests by the shared storage 118 may comprise (i) a time to service the given IO request given available resources of the shared storage 118 and (ii) wait times for IO requests received from the subset of the virtualized computing instances 106 of the given virtualized computing instance workload group.

The two or more IO queues generated for the given virtualized computing instance workload group may comprise a first IO queue associated with a first priority level and at least a second IO queue associated with a second priority level different than the first priority level.

Step 204 may include placing ones of the IO requests having a responsible ratio greater than a threshold value in a first one of the two or more IO queues associated with a first priority level and placing ones of the IO requests having a responsible ratio less than or equal to the threshold value in a second one of the two or more IO queues associated with a second priority level. The responsible ratio for a given one of the IO requests received from the given virtualized computing instance is determined based at least in part on a total wait time associated with IO requests received from the given virtualized computing instance and an amount of time taken to service the given IO request. The threshold value may comprise a value range determined based at least in part on analyzing a flow of the IO requests and available resources of physical infrastructure on which the virtualized computing instances 106 and the shared storage 118 run.

The information characterizing the wait times for the IO requests received from the given virtualized computing instance may comprise one or more of: an average responsible time for each of the IO requests received from the given virtualized computing instance over a designated period of time; an average wait time for each of the IO requests received from the given virtualized computing instance over the designated period of time; a number of IO requests received per second from the given virtualized computing instance over the designated period of time; a rate of random write IO requests received from the given virtualized computing instance over the designated period of time; and an amount of data written to the shared storage 118 by the given virtualized computing instance over the designated period of time.

In step 208, the IO requests received from the subset of the virtualized computing instances 106 of the given virtualized computing instance workload group are processed based at least in part on the different priority levels associated with the two or more IO queues. Step 208 may utilize a multi-priority IO scheduling algorithm. The multi-priority IO scheduling algorithm may be implemented utilizing an NVMe driver of the shared storage 118.

Illustrative embodiments provide technical solutions for optimizing scheduling of IO requests in virtualized computing environments, including but not limited to container-based hyperconverged infrastructure (HCI) environments. HCI is an infrastructure deployment model that combines storage, compute, and network resources into a single cluster. Container-based HCI environments offer flexibility and agility in deploying and managing workloads. The IO characteristics of container-based HCI environments, however, are not well-understood and present various technical challenges.

Container-based HCI environments offer several unique features in terms of IO virtualization. For example, the use of lightweight containerization technology enables faster and more efficient IO operations. Containers share the underlying host operating system kernel, which reduces the need for redundant IO operations and can improve overall performance. Additionally, containers can be deployed and scaled rapidly, which can help to optimize IO performance by quickly allocating and deallocating resources as needed. Container-based IO has several unique features, but it also faces some technical challenges related to efficiency.

One of the key technical challenges of container-based IO is the overhead of IO virtualization. In VM-based virtualized computing environments, IO virtualization is implemented using hypervisors, which can introduce significant overhead. In contrast, container-based IO uses lightweight virtualization technologies, such as Linux Containers (LXC) or Docker, which have lower overhead than VMs. However, the overhead of IO virtualization can still be significant, especially when multiple containers are accessing shared storage resources. Another challenge of container-based IO is the potential for resource contention. Containers running on the same host can compete for shared resources, such as CPU, memory, and network bandwidth. This competition can lead to performance degradation and unpredictable behavior, especially when multiple containers are accessing shared storage resources simultaneously.

The technical solutions described herein provide a scheduling method for classifying and prioritizing different types of IO requests (e.g., originating from containers in a container-based HCI environment), thereby improving IO performance. In some embodiments, a ratio is calculated based on IO data, ensuring fairness and responsiveness in IO operations, while also optimizing or improving resource allocation and guaranteeing sufficient resources are made available for high priority IO requests. The technical solutions thus provide a novel approach for prioritizing concurrent IO (e.g., in container-based HCI environments). In some embodiments, the technical solutions leverage multi-queue priority IO scheduling functionality of NVMe or other storage drivers to achieve optimal or improved performance.

IO performance metrics are collected from an IT infrastructure environment, such as one or more container-based HCI environments. Such IO performance metrics are utilized as input for an algorithm that calculates and distinguishes between different priorities of IO requests (e.g., high, medium and low priority IO requests) based on their associated IO performance metrics. To further optimize or improve IO performance, indicators which are calculated utilizing the algorithm are integrated with multi-queue priority IO scheduling features (e.g., such as that provided for in NVMe drivers). Such features allow for the creation of multiple IO queues with different priorities, ensuring that higher-priority IO requests are serviced first before lower-priority IO requests. By leveraging such features in conjunction with the IO scheduling methods described herein, the technical solutions are able to consistently prioritize higher-priority IO requests resulting in optimal or improved performance in container-based HCI and other IT infrastructure environments.

The technical solutions thus provide a novel scheduling algorithm which calculates indicators for prioritizing IO performance in container-based HCI and other IT infrastructure environments. In some embodiments, such indicators are integrated with multi-queue priority IO scheduling features of NVMe, achieving optimal or improved performance which ensures that higher-priority IO requests are serviced first before lower-priority IO requests. Advantageously, the technical solutions described herein have the potential to enhance the efficiency and reliability of container-based HCI or other IT infrastructure environments, enabling organizations to fully leverage the benefits of such environments.

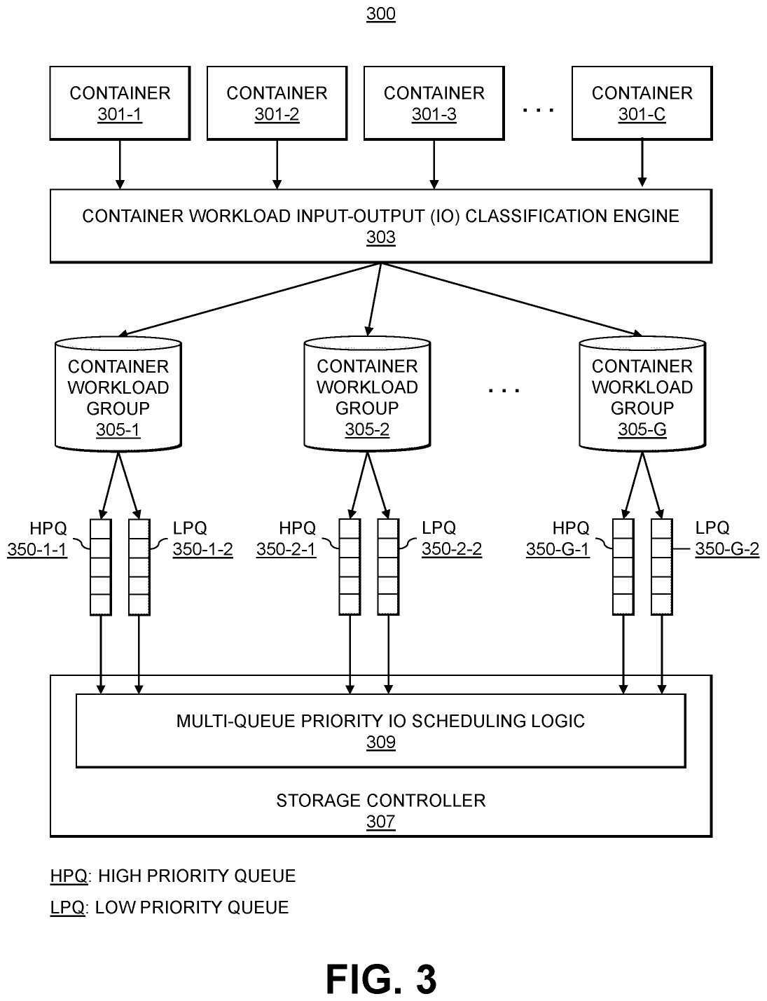

FIG. 3 shows a system 300 configured to implement technical solutions for scheduling IO requests received from a set of containers 301-1, 301-2, 301-3, . . . 301-C(collectively, containers 301) in a container-based HCI environment to improve overall performance and satisfy specific service requirements. It should be noted that that containers 301 of FIG. 3 are examples of the virtualized computing instances 106 which run one or more applications 108 that issue IO requests to shared storage 118. Each of the containers 301 usually runs only one application, also referred to as the container's workload. At the start of each of the containers 301, that container's IO workload type and priority are determined utilizing the container workload IO classification engine 303. The containers 301 are then grouped according to such classifications into a set of container workload groups 305-1, 305-2, . . . 305-G (collectively, container workload groups 305).

The workloads within each of the container workload groups 305 are then sorted by priority in accordance with an algorithm referred to herein as highest response ratio next (HRRN). This produces multiple IO queues for each of the container workload groups 305. For example, container workload group 305-1 has a high priority queue (HPQ) 350-1-1 and a low priority queue (LPQ) 350-1-2. The HPQ 350-1-1 and LPQ 350-1-2 are collectively referred to as multi-priority queues 350-1 associated with the container workload group 305-1. Similarly, the container workload group 305-2 has HPQ 350-2-1 and LPQ 350-2-2, which are collectively referred to as multi-priority queues 350-2 associated with the container workload group 305-2. The container workload group 305-G has HPQ 350-G-1 and LPQ 350-G-2, which are collectively referred to as multi-priority queues 350-G associated with the container workload group 305-G. While in the FIG. 3 example there are two IO queues associated with each of the container workload groups 305 (e.g., an HPQ and an LPQ), this is not a requirement. One or more of the container workload groups 305 may be associated with three or more IO queues (e.g., an HPQ, a medium priority queue (MPQ) and an LPQ). Further, different ones of the container workload groups 305 may be associated with different numbers of IO queues. For example, some container workload groups may be associated with just two IO queues (e.g., an HPQ and an LPQ) while other container workload groups may be associated with three IO queues (e.g., an HPQ, an MPQ and an LPQ) or more than three IO queues. Various other combinations are possible. A storage controller 307 associated with a shared storage system utilized by the containers 301 implements the multi-queue priority IO scheduling logic 309 to service IOs in the multi-priority queues 350-1, 350-2, . . . 350-G (collectively, multi-priority queues 350). The storage controller 307, in some embodiments, comprises an NVMe driver of the shared storage system.

IO prioritization within each of the container workload groups 305 may be performed utilizing the HRRN algorithm, which calculates a responsible ratio (RR) of each IO to dynamically adjust that IO's priority. The output of the HRRN algorithm is separation of IOs into the multi-priority queues 350. The multi-queue priority IO scheduling logic 309 of the storage controller 307 services IOs from the multi-priority queues 350 ensuring fairness and responsiveness for IO requests from the containers 301, optimizing or improving resource allocation and guarantecing sufficient resources for high-priority IO operations.

The HRRN algorithm, which may also be referred to as dynamic container-based HRRN, dynamically optimizes IO scheduling from the containers 301. The HRRN algorithm takes into account application or workload type, IO pattern and responsible time information into consideration for optimizing IO scheduling to help rapidly improve performance in container-based HCI environments and other IT infrastructure environments.

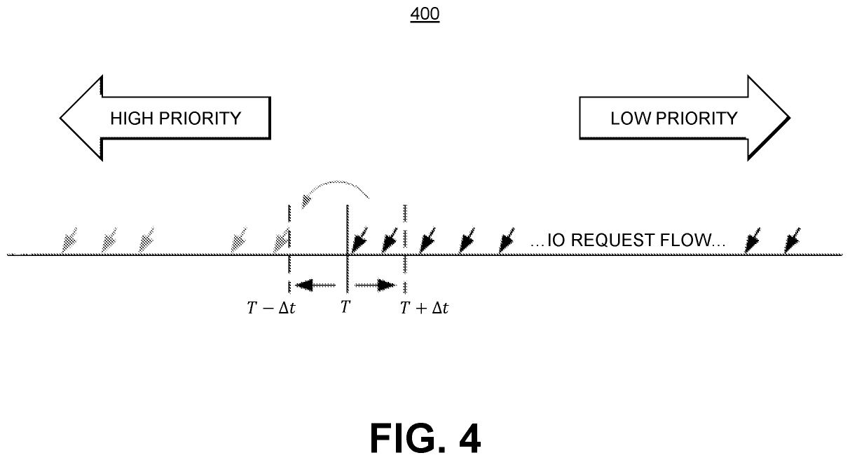

In each of the containers 301, IO priority may be filtered by a threshold T according to the diagram 400 of FIG. 4. IO requests which have a high RR (e.g., an RR greater than T) will be placed in the higher priority queue (e.g., one of the HPQs 350-1-1, 350-2-1 . . . 350-G-1). Otherwise, IO requests will remain in the lower priority queue (e.g., one of the LPQs 350-1-2, 350-2-2, . . . 350-G-2). The threshold T is not a fixed value, and can be modified dynamically in scope (e.g., in a range [T−Δt, T+Δt]), where Δt depends on IO request characteristics and the system resource assignment in a short time period. The threshold T is the key value for determining whether a particular IO request should be moved to a higher or lower priority queue. Considering the fairness of each IO request flow, the threshold T may change in the range [T−Δt, T+Δt]. Methods for determining T and Δt will be discussed in further detail below.

It should be noted that, when more than two priority queues are utilized (e.g., such as an HPQ, an MPQ and an LPQ), similar separation may be applied through the use of two thresholds (e.g., a threshold T₁ for separating between the HPQ and the MPQ, and a threshold T₂ for separating between the MPQ and the LPQ). This can scale as needed depending on the number of queues utilized.

Let the IO stream (also referred to as the IO request flow) and system resources be represented as a matrix, where Cⱼ represents the IO stream and xⱼ represents the system resources. The optimized resulting max z is the expected value to be determined according to:

$$max z = {\sum }_{j = 1}^{n} {C}_{j} {X}_{j}$$

$$s . t . \{ \begin{matrix}{\sum }_{i = 1}^{j} {a}_{ij} {X}_{j} = {b}_{j} , & i = 1 , 2 , … , m \\ {x}_{j} \geq 0 , & j = 1 , 2 , … , n\end{matrix}$$

This may be translated into a matrix as:

$$A - [ \begin{matrix}{a}_{11} & ⋯ & {a}_{1 n} \\ ⋮ & ⋱ & ⋮ \\ {a}_{m 1} & ⋯ & {a}_{mn}\end{matrix} ]$$

Then, according to the requirement that a minimum value of X (X=z=Δt) is needed, that means the value needed is a restrained value, such as:

$${x}_{1} + {x}_{2} + {x}_{3} + … + {x}_{n} \leq m$$

Thus, the problem of the original format may be described as:

$$s . t . \{ \begin{matrix}{ka}_{1} {x}_{1} + {a}_{2} {x}_{2} + {a}_{3} {x}_{3} + ⋯ + {a}_{n} {x}_{n} = p \\ {a}_{1} {x}_{1} + {ha}_{2} {x}_{2} + {a}_{2} {x}_{3} + ⋯ + {a}_{n} {x}_{n} = q \\ {x}_{1} , {x}_{2} , {x}_{3} , … {x}_{n} \geq 0\end{matrix}$$

The optimized result, max z, is the value needed, where Δt=max z. In the equation above, k and h are constant values providing a basic feasible solution to the matrix of the linear programming problem while assuming that x₁=x₂=x₃= . . . =xₙ=0.

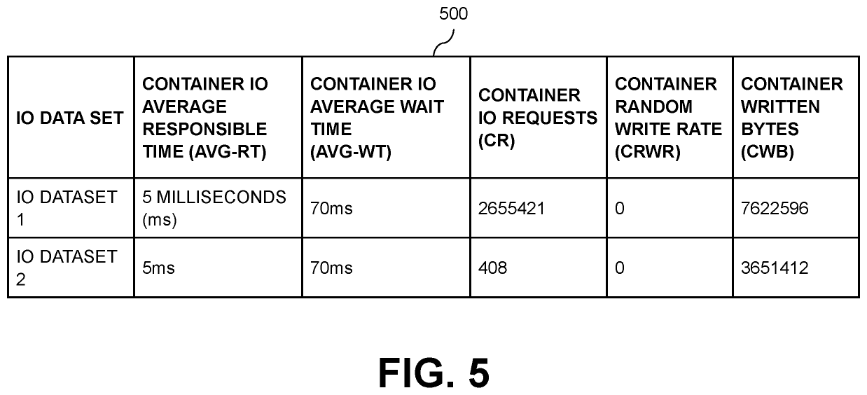

The responsible ratio, RR, will now be described. In some embodiments, a system will pre-process for different types of IO to generate datasets. Different IO workloads may be generated by executing various applications and collecting IO traces. The different IO workloads may include different operations, such as read, write and wait operations for 10,000 files by multi-thread processing. Container IO metrics may be collected to identify each kind of IO's characteristics, and reform them into a dataset of IO workloads. In this way, one thread may be defined for processing IO requests, which will include various kinds of IO operations and associated system resources. For each IO dataset Iₜ, the corresponding columns Tᵢ that capture IO characteristics may include those shown in the table 500 of FIG. 5, where the columns Tᵢ include characteristics such as: container IO average responsible time (AVG-RT) which is the average responsible time for each IO in the container; container IO average wait time (AVG-WT) which is the average wait time for each IO in the container; container IO request (CR) which is the number of IO requests per second for each running container; container random write rate (CRWR) which is the rate of random write IO requests for each running container; and container written bytes (CWB) which is the number of bytes written for each running container. Thus, Iᵢ={AVG-RT, AVG-WT, CR, CRWR, CWB}. It should be noted that the particular values for the different variables shown in FIG. 5 are presented by way of example only. For example, the value of AVG-RT depends on the responsible time of a single IO request processed by the system. For hard disk drives (HDDs), the average single IO responsible time may be around 5 milliseconds (ms). The value of AVG-WT is the average waiting time while the system is processing IO requests, and for HDDs may be around 70 ms or more depending on the load of the system. For other types of drives (e.g., such as solid state drives (SSDs) or other flash-based memory) these values may differ.

The total wait time of each Iᵢ is thus determined according to:

$$Tw = {\sum }_{n = 0}^{∞} {T}_{i}$$

Tr denotes the request served time, which represents how long it takes for a single IO request to be serviced within an IO dataset Iᵢ. The RR may be calculated according to:

$$RR = \frac{Tw + Tr}{Tr} = 1 + \frac{Tw}{Tr}$$

The RR is used for determining IO priority, with a higher value of RR indicating higher relative IO priority.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for IO scheduling for virtualized computing instances issuing IO requests to shared storage will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. Δt least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for IO scheduling for virtualized computing instances issuing IO requests to shared storage as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, virtualization infrastructure, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to identify, for each of a plurality of virtualized computing instances issuing input-output requests to a shared storage system, an input-output workload classification;
to determine two or more virtualized computing instance workload groups based at least in part on the identified input-output workload classifications of the plurality of virtualized computing instances, each of the two or more virtualized computing instance workload groups comprising a different subset of the plurality of virtualized computing instances;
to generate, for at least a given one of the two or more virtualized computing instance workload groups, two or more input-output queues associated with different input-output priority levels;
to sort input-output requests received from the subset of the plurality of virtualized computing instances in the given virtualized computing instance workload group into the two or more input-output queues, wherein a given one of the input-output requests received from a given virtualized computing instance in the subset of the plurality of virtualized computing instances of the given virtualized computing instance workload group is placed in a given one of the two or more input-output queues based at least in part on information characterizing servicing of input-output requests by the shared storage system; and
to process the input-output requests received from the subset of the plurality of virtualized computing instances in the given virtualized computing instance workload group based at least in part on the different priority levels associated with the two or more input-output queues.

2. The apparatus of claim 1 wherein the plurality of virtualized computing instances and the shared storage are part of a hyperconverged infrastructure environment.

3. The apparatus of claim 2 wherein the plurality of virtualized computing instances comprise software containers, and wherein the hyperconverged infrastructure environment comprises a container-based hyperconverged infrastructure environment.

4. The apparatus of claim 1 wherein processing the input-output requests received from the subset of the plurality of virtualized computing instances in the given virtualized computing instance workload group comprises utilizing a multi-priority input-output scheduling algorithm.

5. The apparatus of claim 4 wherein the multi-priority input-output scheduling algorithm is implemented utilizing a Non-Volatile Memory Express driver of the shared storage system.

6. The apparatus of claim 1 wherein the plurality of virtualized computing instances and the shared storage system run on common physical infrastructure in an information technology infrastructure environment.

7. The apparatus of claim 1 wherein sorting the input-output requests received from the subset of the plurality of virtualized computing instances in the given virtualized computing instance workload group into the two or more input-output queues comprises placing ones of the input-output requests having a responsible ratio greater than a threshold value in a first one of the two or more input-output queues associated with a first priority level and placing ones of the input-output requests having a responsible ratio less than or equal to the threshold value in a second one of the two or more input-output queues associated with a second priority level.

8. The apparatus of claim 7 wherein the responsible ratio for a given one of the input-output requests received from the given virtualized computing instance is determined based at least in part on a total wait time associated with input-output requests received from the given virtualized computing instance and an amount of time taken to process the given input-output request.

9. The apparatus of claim 7 wherein the threshold value comprises a value range determined based at least in part on analyzing a flow of the input-output requests and available resources of physical infrastructure on which the plurality of virtualized computing instances and the shared storage system run.

10. The apparatus of claim 1 wherein the information characterizing servicing of input-output requests by the shared storage system comprises (i) a time to service the given input-output request given available resources of the shared storage system and (ii) wait times for input-output requests received from the subset of the plurality of virtualized computing instances of the given virtualized computing instance workload group.

11. The apparatus of claim 10 wherein the information characterizing the wait times for the input-output requests received from the given virtualized computing instance comprises an average responsible time for each of the input-output requests received from the given virtualized computing instance over a designated period of time.

12. The apparatus of claim 10 wherein the information characterizing the wait times for the input-output requests received from the given virtualized computing instance comprises an average wait time for each of the input-output requests received from the given virtualized computing instance over a designated period of time.

13. The apparatus of claim 10 wherein the information characterizing the wait times for the input-output requests received from the given virtualized computing instance comprises at least one of: a number of input-output requests received per second from the given virtualized computing instance over a designated period of time; and an amount of data written to the shared storage system by the given virtualized computing instance over a designated period of time.

14. The apparatus of claim 10 wherein the information characterizing the wait times for the input-output requests received from the given virtualized computing instance comprises a rate of random write input-output requests received from the given virtualized computing instance over a designated period of time.

15. A computer program product comprising a non-transitory processor-readable storage medium having stored therein program code of one or more software programs, wherein the program code when executed by at least one processing device causes the at least one processing device:
to identify, for each of a plurality of virtualized computing instances issuing input-output requests to a shared storage system, an input-output workload classification;
to determine two or more virtualized computing instance workload groups based at least in part on the identified input-output workload classifications of the plurality of virtualized computing instances, each of the two or more virtualized computing instance workload groups comprising a different subset of the plurality of virtualized computing instances;
to generate, for at least a given one of the two or more virtualized computing instance workload groups, two or more input-output queues associated with different input-output priority levels;
to sort input-output requests received from the subset of the plurality of virtualized computing instances in the given virtualized computing instance workload group into the two or more input-output queues, wherein a given one of the input-output requests received from a given virtualized computing instance in the subset of the plurality of virtualized computing instances of the given virtualized computing instance workload group is placed in a given one of the two or more input-output queues based at least in part on information characterizing servicing of input-output requests by the shared storage system; and
to process the input-output requests received from the subset of the plurality of virtualized computing instances in the given virtualized computing instance workload group based at least in part on the different priority levels associated with the two or more input-output queues.

16. The computer program product of claim 15 wherein the plurality of virtualized computing instances comprise software containers, and wherein the plurality of virtualized computing instances and the shared storage are part of a container-based hyperconverged infrastructure environment.

17. The computer program product of claim 15 wherein the information characterizing servicing of input-output requests by the shared storage system comprises (i) a time to service the given input-output request given available resources of the shared storage system and (ii) wait times for input-output requests received from the subset of the plurality of virtualized computing instances of the given virtualized computing instance workload group.

18. A method comprising:
identifying, for each of a plurality of virtualized computing instances issuing input-output requests to a shared storage system, an input-output workload classification;
determining two or more virtualized computing instance workload groups based at least in part on the identified input-output workload classifications of the plurality of virtualized computing instances, each of the two or more virtualized computing instance workload groups comprising a different subset of the plurality of virtualized computing instances;
generating, for at least a given one of the two or more virtualized computing instance workload groups, two or more input-output queues associated with different input-output priority levels;
sorting input-output requests received from the subset of the plurality of virtualized computing instances in the given virtualized computing instance workload group into the two or more input-output queues, wherein a given one of the input-output requests received from a given virtualized computing instance in the subset of the plurality of virtualized computing instances of the given virtualized computing instance workload group is placed in a given one of the two or more input-output queues based at least in part on information characterizing servicing of input-output requests by the shared storage system; and
processing the input-output requests received from the subset of the plurality of virtualized computing instances in the given virtualized computing instance workload group based at least in part on the different priority levels associated with the two or more input-output queues;
wherein the method is performed by at least one processing device comprising a processor coupled to a memory.

19. The method of claim 18 wherein the plurality of virtualized computing instances comprise software containers, and wherein the plurality of virtualized computing instances and the shared storage are part of a container-based hyperconverged infrastructure environment.

20. The method of claim 18 wherein the information characterizing servicing of input-output requests by the shared storage system comprises (i) a time to service the given input-output request given available resources of the shared storage system and (ii) wait times for input-output requests received from the subset of the plurality of virtualized computing instances of the given virtualized computing instance workload group.
